(19) United States
(12) Patent Application Publication
(10) Pub. No.: US 2003/0113499 A1
(43) Pub. Date: Jun. 19, 2003

(54) Industrial adhesive tape for improved sealing of joints and an industrial adhesive tape dispenser

(76) Inventors: Reto Sieber, Sigigen (CH); Marco Sieber, Horw (CH)

Correspondence Address: JORDAN AND HAMBURG LLP, 122 EAST 42ND STREET, SUITE 4000, NEW YORK, NY, 10168, US

(21) Appl. No.: 10/311,736

(22) PCT Filed: Jun. 18, 2001
(86) PCT No.: PCT/EP01/06851

(30) Foreign Application Priority Data
Jun. 27, 2000 (DE) 10031214.4

(51) Int. Cl. B32B 9/00

(52) U.S. Cl. 428/40.1

(57) ABSTRACT

A pressure-sensitive tape for closing, sealing and gluing joints in house construction is proposed, with a backing (1) on the upper side of the tape and with an adhesive layer (2), which is provided on the underside of the tape and has a covering film (3), which can be pulled off, the covering film having at least one slit (6) in the longitudinal direction and the tape being folded upon itself along the slit (6), so that at least a part of the covering film (3) is disposed on the outside.

The present invention relates to a pressure-sensitive tape for closing off, sealing and gluing joints in house construction, a so-called assembly adhesive tape, which is suitable particularly for joints in corners and edges, as well as to a dispenser for such a tape. Such adhesive tapes are used, for example, in house construction, when different construction elements, such as doors or the windows, are inserted in an external wall of a house and the joint, formed between the element and the exterior wall of the house, must be closed off. Such pressure-sensitive tapes have a backing layer, with which an adhesive layer is connected, the adhesive layer usually being provided with a covering film, which can be pulled off.

It is a problem of such pressure-sensitive tapes that it is difficult to apply the tape in regions, which are not readily accessible, so as to seal the joint well and, at the same time, to glue the backing layer smoothly on the joint section, in order to achieve sealing of these joints, which is as air-tight and moisture-tight as possible.

A further problem consists therein that, in processing the tape, the covering film frequently can be removed only with difficulty from the adhesive layer, since no means are provided at the smooth cut edges of the adhesive tape in order to be able to lift and pull off the covering film from the section of tape, which is to be glued.

It is an object of the invention to make available a pressure-sensitive tape for closing off, sealing and gluing joints, which can be glued easily and effectively even in regions, to which access is difficult, such as corners and edges, and which, moreover, facilitates the gluing process and the use of the tape in these regions. A further object of the invention is the improvement in the storage, transport and processing of the pressure-sensitive tape.

This objective is accomplished with a pressure-sensitive tape having the distinguishing features given in claim 1 and with a dispenser for an adhesive tape of claim 18. Advantageous embodiments and further developments are the object of the dependent claims.

In the longitudinal direction, the covering film of the inventive, pressure-sensitive tape has at least one slit and, in the transverse direction, the tape is folded upon itself along this slit, so that at least a portion of the covering film is disposed on the outside. In this way, the covering film can easily be raised and pulled off from the adhesive film at the fold of the tape towards its two sides, since the covering film is slit at the fold and, by these means, the edges of the covering film are detached somewhat from the adhesive layer. The edges of the covering film, which are detached already somewhat, can easily be taken hold of by the fingers, even under difficult conditions, so that the problem of a covering film, which cannot be detached or is difficult to pull off, does not exist. Moreover, the tape can also be processed more easily due to the folding and the slit covering film. To begin with, the tape can be glued with only a portion of the covering film pulled off parallel to the joint and corner in the corner joints, which are to be glued. Subsequently, when the adhesive tape is already glued to one side of the joint section, the opposite side of the covering film can easily be pulled off completely and glued over the joint. Prefolding the adhesive tape also prevents, for example, the unintentional folding or shifting of the glued tape, which leads to undesirable leaks and problems with the further processing of the glued region of the joint.

When gluing pressure-sensitive tape over joints, which are in 90° corners (such as joints between window frames and exterior walls of houses), the prefolded tape ensures very precise gluing in the respective corner.

The tape can be glued separately and consecutively with the folded longitudinal sections. By these means, it is prevented that the strongly adhering tape is glued untidily and that adhesive or adhesive tape residues visibly remain behind by pulling off and gluing once again. Moreover, there is no indication of glue lines since, due to the prefolding, the tape can be glued very accurately and straight in the corners, so that the processing is simplified significantly by these means.

The time saved while processing the pressure-sensitive tape is a further advantage of the prefolding. The previously required manual prefolding of the tape, piece by piece, can now be omitted completely, so that the gluing time during the processing of the inventive tape can be shortened by up to a half.

According to an advantageous development of the invention, the tape has two slits and is folded along one of the slits in the transverse direction. This has the advantage that the covering film can be pulled off in small longitudinal sections successively from the adhesive layer, so that the adhesive tape can be applied even more easily and glued more precisely. To begin with, the tape can be glued in a very small edge section. Subsequently, the next section of covering film can be pulled off in order to glue the tape further. Only at the very end is it necessary to pull off the last section of the covering film, for example, the section on the folded-over tape side, which was kept until then to prevent contamination or the gluing in an unintentional manner.

According to a further advantageous development of the invention, the backing consists of paper and/or a plastic film and the adhesive layer of a pressure-sensitive acrylate adhesive. As a result, the pressure sensitive tape, even in the folded state, is insignificantly thicker than conventional assembly adhesive tapes and applies very little on the substrate, even in the glued state, so that the adhesive tape can also be glued in regions in which, for example, floor coverings, wallpaper or plaster is subsequently to be laid or applied. On the one hand, because of its good adhesive properties, the acrylate adhesive is very suitable for gluing corner joints and, on the other, it ensures a long-lasting adhesive effect even under extreme weather and weathering conditions, for example, in an exterior region.

According to a further advantageous development of the invention, the backing is such, that it can be torn by hand transversely to the longitudinal direction of the tape. By these means, the tape can be divided easily into longitudinal sections corresponding to the respective joint length. It is therefore easier to process the tape.

According to a further advantageous development of the invention, the adhesive layer has an adhesive central strip and the covering film is slit and folded along a line between the adhesive central strip and an adjoining adhesive layer. This is particularly advantageous for gluing joints between two components adjoining one another at right angles since a skew or displaced gluing is easily prevented by these means particularly in the butt joint region of the components. Nevertheless, the adhesive tape ensures a reliable sealing and closing of the joint even over edges and corners, since the two outer edge adhesive regions of the tape are sufficiently wide and are glued only onto flat surfaces.

According to a further advantageous development of the invention, the tape, in the folded state, is rolled up into an adhesive tape roll. The adhesive layer, exposed at the fold, can in this way not adhere to other adhesive tape regions and a swift and simple processing of the adhesive tape is possible without making prior preparations for the adhesive process. Pieces of tape, cut to length, can easily be taken from the roll and glued without delay on one side after the covering films are pulled off. The step of prefolding the tape before applying it on the joint, which is to be closed off, is dispensed with; gluing joints can therefore be carried out faster and more inexpensively than previously.

According to a further advantageous development of the invention, an intermediate layer is provided at least at the folded side of the roll. The intermediate layer ensures here that, during transport or storage of the rolled-up and folded tape, the latter cannot adhere to the exposed adhesive side of the fold. Moreover, by these means it is prevented that dirt and the like, which could have a disadvantageous effect on the adhesive action of the tape, could deposit at this side.

According to a further advantageous development of the invention, the tape is rolled up on a matching unrolling device, from which it can be unrolled once again. By these means, the cumbersome unpacking and storing of the pressure-sensitive tape is dispensed with, since the latter can be unrolled once again easily from the unrolling device and cut from the roll in the required lengths. However, the unrolling device not only simplifies the removal of the tape, but also serves as protective and transporting packaging. Moreover, the unrolling device can be used as a processing means in that, for example, the pressure-sensitive tape is unrolled some distance from the device, the pressure-sensitive film is pulled off piece by piece on one of the folded sides and the tape subsequently is unrolled and glued over a longer segment continuously and directly from the roll onto one of the sides of the joint.

According to a further development of the invention, advantageous in this respect, means are provided at the folded side for preventing adhesion with this and in the unrolling device. For this purpose, for example, a siliconized paper, corresponding to the diameter of the roll, can be placed laterally on the rolled-up tape, from which, in spite of a slight adhesion to the tape at the fold, this paper can be removed once again easily. By these means, the siliconized paper prevents lateral gluing in the interior of the unrolling device in that, while it adheres slightly to the side of the tape roll, it turns along on the device together with the roll during the unrolling or removal.

According to a further advantageous aspect of the invention, a dispenser is provided for the pressure-sensitive tape, which is wound up into a roll. This dispenser essentially encloses the roll and has at least one outlet slot for the adhesive tape. The dispenser has the advantage of a protective encasement for transport while, at the same time, the handling is simplified and the pressure-sensitive tape is processed continuously. Even if the surrounding conditions are very dusty, dirt is prevented from reaching the exposed adhesive sites and reducing the adhesive force. The adhesive tape, enclosed by the dispenser, can be unrolled easily out of the outlet slot and removed and glued or cut off and glued continuously (in the case of long adhesion sites) or piece by piece (in the case of short adhesion sites) directly from the dispenser.

An example of the inventive assembly adhesive tape as well as of the assembly adhesive dispenser is shown in the drawing, which is described in greater detail in the following with reference to the Figures, of which

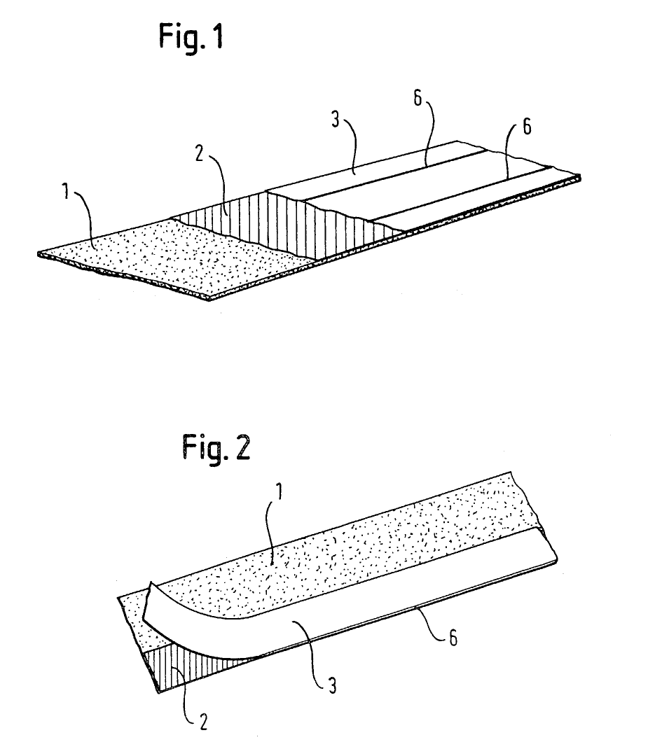

FIG. 1 shows an example of an assembly adhesive tape, which has not yet been folded upon itself,

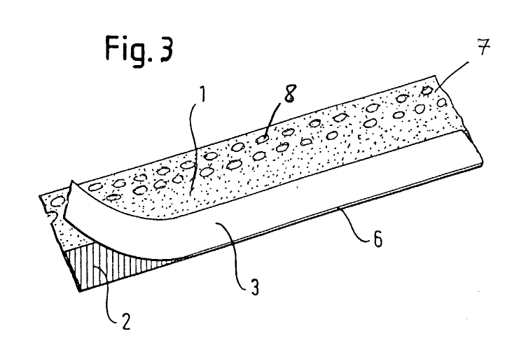

FIG. 2 shows the assembly adhesive tape of FIG. 1, for which a portion has been folded upon itself and

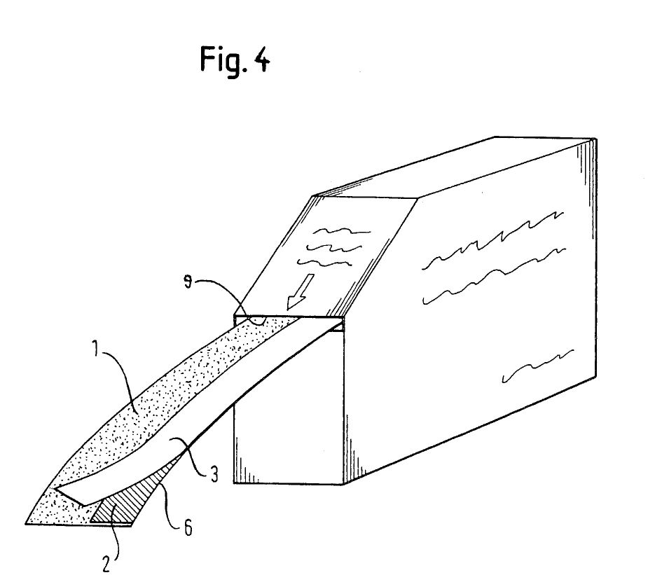

FIG. 3 shows a diagrammatic representation of an assembly tape dispenser of an inventive assembly adhesive tape, folded upon itself.

In FIG. 1, an assembly adhesive tape is shown, which has a backing 1, an adhesive layer 2 and a covering film 3. The covering film 3 has two slits 6 in the longitudinal direction of the tape. Because two longitudinally disposed slits 6 are provided, it is possible to fold the outer regions of the assembly tape onto themselves, the slits 6 being disposed in such a manner that either the folded-over tape regions lie on one another or that the tape regions are folded onto the tape, so that the folded regions are not disposed over one another.

In FIG. 2, the inventive assembly adhesive tape is shown, which has a basic construction similar to that of FIG. 1. The assembly adhesive tape has the backing 1, the adhesive layer 2, which preferably consists of acrylate adhesive, and the covering film 3. The assembly adhesive tape is folded upon itself along an essentially continuous slit 6. The tape has width of 3 to 4 cm. It is also possible that the slit 6 of the covering film is disposed essentially in the center of the tape and therefore one-half of the tape is folded onto the other half. In FIG. 2, only a part of the whole width of the tape is folded onto itself along the slit 6. The adhesive layer 2 consists of more than 100 g/m² and preferably of 200 g/m² of acrylate adhesive. The tape is folded along the slit 6 in the covering film 3 so that the covering film in the fold, which consists, for example, of a siliconized paper, can easily be detached from the adhesive layer 2 and thus be taken hold of by hand without any problem and pulled off. The whole tape is rolled up in the folded state into a roll and provided at the sides with intermediate layers for transport and packaging. The intermediate layers are, for example, siliconized, circular sheets of paper, the diameter of which correspond to the diameter of the rolled-up tape. The circular sheets of paper are siliconized, so that the tape can easily be detached from them even if there is slight adhesion at the exposed fold. Other means, familiar to those skilled in the art, can also be provided as adhesive means.

At least on its side averted from the adhesive layer 2, the backing I has a bright color, such as white or the like, so that a joint, sealed with the adhesive tape, can also be provided with thin plaster layers, a thin bright layer of paint and the like, without the color of the tape interfering subsequently by showing through. In this example, the tape has a width of 3 to 4 cm. However, it is self-evident that wider inventive, pressure-sensitive tapes up to a maximum width of 50 cm can also be provided depending on the requirements and the width of the joints, which are to be sealed.

FIG. 3 is a diagrammatic representation of an assembly adhesive tape dispenser, in which an assembly tape of FIG. 2, folded onto itself, is accommodated. For use, the assembly adhesive tape leaves the dispenser through an outlet slot 7, which is provided at the front of the dispenser. Preferably, the dispenser is made from cardboard and the assembly adhesive tape can advantageously be offered for sale and used in the unit with the assembly adhesive tape. This has the advantage that the assembly adhesive tape is protected against becoming contaminated, especially at the immediate fold lines, since parts of the adhesive layer are exposed at these fold lines. Not only can the assembly adhesive tape be transported reliably with the dispenser, but it can also be used safely at a building site, protected against contamination. The dispenser may be constructed as a disposable article, that is, disposed of after the assembly adhesive tape has been used up completely, or as a refillable box.

1. Pressure-sensitive tape for closing, sealing and gluing joints in house construction, especially joints in corners and edges, with a backing on the upper side of the tape and with an adhesive layer, which is provided on the underside of the tape and is provided with a covering film, which can be pulled off, wherein the covering film has at least one slit in the longitudinal direction and the tape is folded upon itself in the transverse direction along the slit so that at least a part of the covering film is disposed on the outside.

2. The tape of claim 1, wherein the tape has two slits and is folded along one of the slits in the transverse direction.

3. The tape of claims 1 or 2, wherein the backing consists of paper and/or plastic film and the adhesive layer is a pressure-sensitive acrylate adhesive.

4. The tape of one of the preceding claims, wherein the backing is such, so that it can be torn by hand transversely to the longitudinal direction of the tape.

5. The tape of one of the preceding claims, wherein the adhesive layer has an adhesive central strip and the covering film is slit along a line between the adhesive central strip and the adjoining adhesive layer and folded along the line.

6. The tape of one of the preceding claims, wherein it is rolled up in the folded state into an adhesive tape roll.

7. The tape of claim 6, wherein an intermediate layer is provided at least at the folded side of the roll.

8. The tape of one of the preceding claims, wherein it is rolled up on a fitting unrolling device, from which it can be unrolled once again.

9. The tape of claim 8, wherein at least at the folded side, means are provided for preventing adhesion to the unrolling device.

10. The tape of one of the preceding claims, wherein it is at least 3 to 4 cm wide in the unfolded state.

11. A dispenser for a pressure-sensitive tape of one of the claims 1 to 10, which is rolled up into an adhesive tape roll, the dispenser essentially enclosing the adhesive tape roll and having at least one outlet slot for the tape.

12. The dispenser of claim 11, wherein cardboard is used as material.
